(19) United States
(12) Patent Application Publication
(10) Pub. No.: US 2026/0316411 A1
(43) Pub. Date: Oct. 15, 2026

(54) AN ACOUSTIC PANEL PRODUCT FROM TEXTILE FABRIC WASTES AND A PRODUCTION METHOD THEREOF

(71) Applicant: OBA PERDESAN TEKNIK TEKSTIL ANONIM SIRKETI, Istanbul (TR)

(72) Inventors: Alp Yaman ALTUG, Istanbul (TR); Onur AYDIN, Istanbul (TR)

(73) Assignee: OBA PERDESAN TEKNIK TEKSTIL ANONIM SIRKETI, Istanbul (TR)

(21) Appl. No.: 18/869,833

(22) PCT Filed: Apr. 1, 2024
(86) PCT No.: PCT/TR2024/050331

§ 371 Date: Nov. 26, 2024

(30) Foreign Application Priority Data
Dec. 12, 2023 (TR) 2023/017063

(51) Int. Cl. B29D 7/00; B29K 105/00; B29K 105/26; E04B 1/99

(52) U.S. Cl. CPC B29D 7/00; E04B 1/99; B29K 2105/25; B29K 2105/26

(57) ABSTRACT

The invention relates to an acoustic panel product produced by reusing waste curtain fabrics, which are technical textiles, and a production method of this panel.

### TECHNICAL FIELD

The invention relates to an acoustic panel product produced by reusing waste curtain fabrics, which are technical textiles, and a production method of this panel. The panel produced by said production method is environmentally friendly, 100% recyclable and has a high sound absorption coefficient.

### STATE OF THE ART

An acoustic panel is decorative panels produced for sound insulation, comprising special sound-absorbing materials. In addition to being used for sound insulation, an Acoustic panel is also used as a decorative material for indoor applications. Basically, it is divided into two categories: fabric-covered and wood-covered. Fabric acoustic panels of an appropriate quality provide both good sound insulation and a stylish appearance. An acoustic panel is a type of a decoration product used on floors, walls and ceilings in environments where the sound loss is important. It is used to prevent the transition of a sound in one area to another.

Today, acoustic panels are the most preferred sound insulation material in many places and in many areas. It is preferred not only for sound insulation but also as a decoration article. These panels providing an acoustic comfort for the designed areas may be positioned in the form of the stretched fabrics, panels, and ceiling-mounted objects. The panels have sound absorption properties due to the core material from which they are made. The core material absorbs sound, preventing sound from propagating through the air. Due to its internal structure consisting of a high-density rock wool board, it is resistant to any external impact or fire. With different types and material options, the acoustic panels may be used in different fields.

The acoustic panel prevents sound pollution in the application area and offers the best sound quality. Acoustic panels are especially used in areas where the mass communication is provided (cinemas, meeting rooms, theaters, conferences, etc.), and they are the panels which are used to prevent sound vibration waves from hitting objects and echoing. In order to solve the noise problem in the environment, there are mainly 4 types of products in the state of the art. These are sponge acoustic panels prepared by cutting standard-sized panels with a CNC knife, decorative perforated wood panels prepared by being cut with laser CNC, decorative fabric-covered panels prepared by inserting a rock wool and/or a glass fiber into a wooden pulley and covering with a fabric, and a decorative polyester acoustic panel produced from 100% new fiber or by blending the recycled fibers and the new fibers. All of the materials used for the production of said acoustic panels are intended to provide a new product from nothing, and no recycled material is used. All of the materials for the production of panels are brand new products intended for the consumption sector allocated to produce products.

An example of environmentally friendly acoustic panels in the state of the art is generally obtained from long-term production steps of plastic bottles made of a recycled PET (Polyethylene terephthalate) material. The recycling process of plastic bottles made only of a PET material consists of an average of 10 steps. These steps are generally as follows: separating, primary shredding, transporting, washing, hot air drying, secondary shredding, subjection to a water tank, drying, extrusion, pelletizing. Said recycling process is a disadvantageous process in terms of both time and labor.

Thus, a method should be developed, which minimizes or eliminates the above-mentioned disadvantages in the state of the art.

### SUMMARY OF THE INVENTION

One of the advantages of the invention is that a production process which will not cause an additional carbon footprint may be realized due to the use of waste products for the production of acoustic panels. There will be no need for additional process steps for processing the material to be used for the acoustic panel production and material, labor and time savings may be achieved.

Another advantage of the invention is that the large waste burden in the textile sector, especially in the field of curtain garments, will be reduced and thus an environmentally friendly and sustainable acoustic panel will be produced. By reusing the wastes generated during the production process, the spread of polymer-based wastes to the environment will be prevented. In addition, a panel with high sound absorption characteristic is possible to be produced using a technical textile (light-proof, flame-retardant) fabric during the panel production process.

### DESCRIPTION OF THE DRAWINGS

FIG. 1 is a representative view of the acoustic panel obtained by the method of the invention.

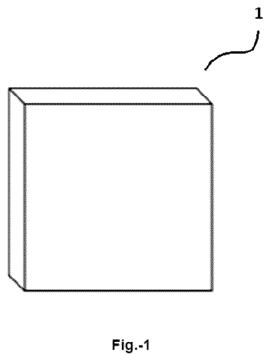

FIG. 2 is a representative flow diagram of the method of the invention.

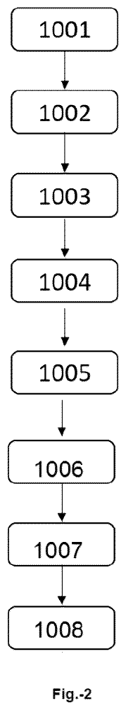

### DESCRIPTION OF THE REFERENCES IN THE DRAWINGS

In order to provide a better understanding of the invention, the numerals in the drawings are provided below:
1. Panel
1001. Collecting the wastes
1002. Shredding the wastes by fiber openers in an opening machine
1003. Homogenizing the waste fibers to be recycled
1004. Placing the wastes in molds suitable for the panels of the desired size
1005. Hot pressing the molds in press machines
1006. Cooling the pressed molds
1007. Removing the cooled panels from the mold
1008. Coloring and sizing the panels

### DETAILED DESCRIPTION OF THE INVENTION

Exemplary embodiments are described in more detail below with reference to the accompanying descriptions. However, embodiments may be constructed in different forms and should not be construed as limited to the embodiments set forth herein. Instead, these exemplary embodiments are provided for the completeness of this disclosure and to fully convey its scope to those skilled in the art.

The terminology used in this specification is intended to be used only to describe a specific exemplary embodiment and is not intended to be restrictive. As used herein, the forms “one”, “least”, and “preferably” are also intended to include plural forms unless the context clearly states otherwise. When the terms “contains” and/or “including” are used in this specification, they include the presence or addition of specified properties, integers, steps, operations, elements, and/or components, but do not preclude one or more other features, integers, steps, operations, elements, and/or components.

A production method of an acoustic panel according to the invention from the textile fabric wastes comprises the following process steps:
I. Collecting the waste (1001),
II. Shredding of wastes by fiber openers in an opening machine (1002),
III. Homogenizing the waste fibers to be recycled (1003),
IV. Placing the wastes in molds suitable for the panels of the desired size (1004),
V. Hot pressing the molds in the press machines (1005),
VI. Cooling the pressed molds (1006),
VII. Removing the cooled panels from the mold (1007), and
VIII. Coloring and sizing the panels (1008).

In the method of the invention, waste technical textile fabrics are collected in waste collection containers based on their types. Wastes may consist of technical textiles with different properties. According to an embodiment of the invention, said waste fabrics are light-proof pieces of a curtain fabric, preferably with flame retardant characteristics. Binders are used to keep the structure stable and to improve the performance characteristics thereof during the production of the acoustic panels from wastes without any coating. Said binder may be polymer-based company wastes and/or low-melting polyester. The rate of binder added is in the range of 5-60%. In addition, 100% blackout curtain fabric wastes are reused, while the additional binders are used to improve the performance characteristics. Unlike other wastes, blackout fabrics are obtained by coating a polyester fabric with a polymeric foam paste. The collected fabrics are shredded by the fiber openers in a fiber opener machine. As the fibers are dyed and/or coated, a fiber opening process cannot be done using standard fabric opening machines. A tandem 3-drum, 3-step fiber opening system is used for the corresponding opening process. The fiber which cannot be opened in the first part is opened in the other parts and becomes a fibrous structure. The opened fiber is placed in suitable molds to be produced in a desired thickness (preferably 0.3-2 cm) and size. The waste fibers placed in the mold are pressed in the hot press machine at a temperature in the range of 100-300 °C, preferably at a temperature of 150-200 °C, by applying a pressure in the range of 1-50 tons. Upon the completion of the hot molding process, the panels which are preferably cooled at room temperature (25 °C) are removed from the mold. Here, additional cooling systems may be optionally used for the cooling process. The cooling duration may be shortened by passing a refrigerant and/or water around the molds with the temperature of 25 °C being optimal. As a final process, a coloring and sizing process of any type is performed.
The sound absorption performance tests of the acoustic panel produced by the method of the invention were carried out in the range of 200-6400 Hz according to the ISO 10534-2 standard.

### INDUSTRIAL APPLICABILITY OF THE INVENTION

The panels produced by a production method of an acoustic panel according to the invention from the textile fabric wastes may be used in any fields, including automobiles, aircrafts, defense vehicles, in particular workplaces with common working areas, libraries, airports, terminals, metro stations, places with stages such as cinemas and theaters, hotels, cafes and restaurants, production facilities, and have an industrial applicability.

The invention is not limited to the above exemplary embodiments, and a person skilled in the art may easily present other different embodiments of the invention. These should be considered within the scope of protection of the invention claimed in the claims.

1. A production method of an acoustic panel from textile fabric wastes,
collecting the waste;
shredding of wastes by fiber openers in an opening machine;
homogenizing the waste fibers to be recycled;
placing the wastes in molds suitable for the panels of the desired size;
hot pressing the molds in the press machines;
cooling the pressed molds;
removing the cooled panels from the mold; and
coloring and sizing the panels.

2. The method according to claim 1, comprising adding low-temperature melting fibers, wood fibers, and/or binders are added to the waste fibers for said homogenization in the process step of homogenizing the waste fibers to be recycled.

3. The method according to claim 1, where the press temperature is in the range of 100-300 °C in the process step of hot pressing the molds in the press machines.

4. The method according to claim 1, where the press pressure is in the range of 1-50 tons in the process step of hot pressing the molds in the press machines.

5. A panel produced by a method according to of claim 1.
